(19) United States
(12) Patent Application Publication
(10) Pub. No.: US 2004/0148707 A1
(43) Pub. Date: Aug. 5, 2004

(54) Condensates for the retanning of Fe-tanned leather

(76) Inventors: Martin Kleban, Leverkusen (DE); Ahmet Kaplan, Leverkusen (DE); Kirsten Markgraf, Weinheim (DE); Dietrich Tegtmeyer, Bergisch Gladbach (DE); John D. Whiteman, Churchville, PA (US)

Correspondence Address: BAYER CHEMICALS CORPORATION, PATENT DEPARTMENT, 100 BAYER ROAD, PITTSBURGH, PA, 15205-9741, US

(21) Appl. No.: 10/694,382

(22) Filed: Oct. 27, 2003

(30) Foreign Application Priority Data
Oct. 28, 2002 (DE) 10250112.2

(51) Int. Cl. C14C 1/00

(52) U.S. Cl. 8/94.15

(57) ABSTRACT

A process for the retanning of iron-tanned leather, comprising applying to iron-tanned leather condensates based on:

A) sulphonated aromatics,

B) aldehydes and/or ketones and optionally

C) one or more compounds selected from the group consisting of the unsulphonated aromatics, urea and urea derivatives

for the retanning of iron-tanned leather, with the proviso that the content of naphthalenesulphonic acid/formaldehyde condensate and condensate based on phenol and formaldehyde is less than 25% by weight, preferably less than 5% by weight, based on the total amount of condensate.

### BACKGROUND OF THE INVENTION

1. Field of the Invention

The invention relates to the use of special condensates for the retanning of iron-tanned leather, a process for the retanning of iron-tanned leathers and leathers containing corresponding condensates.

2. Background of the Invention

Tanning with iron is already known in the art, cf. Stather, Gerbereichemie und Gerbereitechnologie [Tanning Chemistry and Tanning Technology], Akademie Verlag, Berlin, 1957, 474480; Heidemann E. et al., Möglichkeiten und Grenzen der Eisengerbung [Possibilities and Limits of Iron Tanning], Das Leder, 1990, 8-14; Balasubramanian S. et al., Iron Complexes as Tanning Agents, JALCA, 1997, 218-224.

The iron-tanned leathers, for example, in Heidemann (see above) were retanned with commercial naphthalenesulphonic acid/formaldehyde condensates (TANIGAN® BN, available from Bayer AG) or phenol condensates (BASYNTAN® DLX, available from BASF AG). However, the leathers thus obtained are still unsatisfactory with regard to their softness (cf. example 7) and are not suitable for upholstery leather or automotive covering leather.

It was therefore an object of the present invention to provide soft iron-tanned leathers.

### SUMMARY OF THE INVENTION

The invention therefore relates to the use of condensates based on

A) sulphonated aromatics,

B) aldehydes and/or ketones and optionally

C) one or more compounds selected from the group consisting of the unsulphonated aromatics, urea and urea derivatives for the retanning of iron-tanned leather, with the proviso that the content of naphthalenesulphonic acid/formaldehyde condensate and those based on phenol and formaldehyde is less than 25% by weight, preferably less than 5% by weight, based on the total amount of condensate.

### DETAILED DESCRIPTION OF THE INVENTION

As used herein, the term “based on” means that the condensate was optionally prepared from other reactants in addition to A, B and optionally C. In the context of this application, however, the condensates are preferably prepared only from A, B and optionally C.

As used herein, the term “based on phenol and formaldehyde” means that the condensate is prepared from further reactants, for example phenolsulphonic acid and urea, in addition to phenol and formaldehyde.

In the context of this application, the term “retanning” is understood as meaning the aftertreatment of iron-tanned leather in order to optimize colour, levelness, softness, body and the behaviour towards water (hydrophobic properties) and to fix tanning agents.

The iron-tanned leather is preferably also chromium-free. In the context of the present invention, the term “chromium-free” means not tanned with chromium salts. Hence, the maximum amount of chromium, for example due to natural sources of Cr fractions in animal hides or chromium-containing dyes, in leather is less than 2000 ppm.

For leathers not tanned with chromium dye, the maximum amount of chromium in the leather is preferably less than 100 ppm.

The leather used for the retanning preferably has a shrinkage temperature greater than 70° C., in particular greater than 75° C.

The iron-tanned leather preferably has an iron content of 1 to 7% by weight. The iron content is determined as follows: A sample of the leather is dried at 70° C. in vacuo to constant weight to obtain the reference weight. Thereafter, ashing is effected at 800° C., and the content of Fe(III) is determined by a commercial wet-chemical method and related to the reference weight.

The iron content preferably results from the tanning with iron salts. Preferred iron salts are those of iron in oxidation state +3, for example iron chloride, iron sulphate and basic iron sulphate, and those of iron in oxidation state +2, such as iron sulphate. The amount of Fe(III) or Fe(II) is preferably from 0.3 to 5% by weight, in particular 1 to 3% by weight, based on the pelt used.

The use according to the invention preferably leads to leathers having a softness greater than 15 units, preferably greater than 20, in particular greater than 30, measured according to IUP/36, using an ST 300 measuring instrument from Heights Design Production Ltd., Halifax, UK or an equivalent instrument.

In order to improve the surface properties and physical fastnesses, the leathers obtained can be finished with a polymeric film using commercial products and machines, as described, for example, by W. Wenzel, Aqueous Finishing of Leather, JALCA, 1991, 442-455.

In the context of this application, it is understood that sulphonated aromatics means sulphomethylated aromatics and biaryl sulphones. Preferred sulphonated aromatics are: naphthalenesulphonic acids, phenolsulphonic acids, sulphonated ditolyl ethers, 4,4′-dihydroxydiphenyl sulphone, sulphonated diphenylmethane, sulphonated biphenyl, sulphonated terphenyl or benzenesulphonic acids.

Suitable aldehydes and/or ketones are in particular aliphatic, cycloaliphatic and aromatic ones. Aliphatic aldehydes are preferred, with formaldehyde and other aliphatic aldehydes having 2 to 5 C atoms being particularly preferred.

Illustratively, phenol, cresol and dihydroxydiphenylmethane are suitable as unsulphonated aromatics.

Illustratively, dimethylolurea, melamine and guanidine may be mentioned as urea derivatives.

Phenol and phenol derivatives, such as, for example, phenolsulphonic acid, are often also linked by the simultaneous action of formaldehyde and urea or by dimethylolurea (DE-A 1 113 457). Sulphonation products of aromatic compounds are (according to Ullmanns Encyklopädie der technischen Chemie [Ullmann's Encyclopaedia of Industrial Chemistry], Volume 16 (4th edition) Weinheim 1979, page 138) as a rule condensed with formaldehyde, without separating off the unconverted starting compounds, alone or together with further starting compounds. A solubilizing group can be introduced in the case of phenols also by sulphomethylation with the simultaneous action of alkali metal bisulphite and formaldehyde together with the condensation. This sulphomethylation is described, for example, in DE-A 848 823.

Further preferred condensates are condensates of ditolyl ether sulphonic acid with 4,4′-dihydroxydiphenyl sulphone, and phenolsulphonic acid with phenol and urea.

Particularly preferred condensates are those which are obtained by condensation of sulphonated and optionally unsulphonated aromatics with aliphatic aldehydes, preferably formaldehyde, with sulphonated aromatics being understood in particular as not meaning sulphomethylated aromatics.

Such condensates are preferably obtained by condensation of sulphonated phenol and/or 4,4′-dihydroxydiphenyl sulphone with formaldehyde.

The condensate preferably obtained in the condensation preferably has a degree of condensation of from 2 to 150, preferably from 2 to 20 and preferably a preferred average molecular weight, determined as the number average, of from 500 to 35000 g/mol. Particularly preferred condensates have a molecular weight of less than 3000 g/mol.

In a particularly preferred embodiment of the invention, the condensates are prepared from:

A) sulphonated aromatics,

B) formaldehyde and optionally

C) unsulphonated aromatics.

Condensation generally takes place at a pH of from −1 to 9. In a particularly preferred embodiment, the condensation of sulphonated and optionally unsulphonated aromatics, carrying no hydroxyl groups, with aldehydes and/or ketones, in particular an aldehyde, preferably formaldehyde, and optionally urea or urea derivatives, is effected in the acidic pH range. The condensation of sulphonated aromatics which carry hydroxyl groups with an aldehyde, in particular with formaldehyde, is preferably effected at pH 6-8. The condensates are preferably present as alkali metal, alkaline earth metal or ammonium salts or as mixtures thereof. Particularly preferred salt forms are the Na, K, Li, NH₄₋, Ca, Mg or NR₁R₂R₃R₄ salts, with R₁ to R₄ denoting identical or different C₁-C₈-alkyl or C₆-C₁₀-aryl radicals or H.

Before or after condensation, acid optionally originating from the preceding sulphonation of the aromatics and/or acid used in the condensation reaction can preferably be completely or partly neutralized. After condensation is complete, a pH of from 3 to 8 is preferably established. The pH is preferably established so that a 1% strength solution has the stated pH. In particular, an inorganic base, such as, for example, NaOH, Na₂CO₃, KOH, LiOH or NH₄OH, is used for this purpose.

The sulphonation of the aromatics for the preparation of the abovementioned sulphonated aromatics is effected as a rule by generally known processes, as described, for example, in DE-A 29 34 980. For example, chlorosulphonic acid, amidosulphonic acid, oleum and sulphuric acid can be used as suitable sulphonating agents.

The reaction mixture obtained is preferably used for the subsequent condensation, without intermediate isolation of the sulphonated aromatics being effected. The reaction mixture is preferably used without the unsulphonated aromatics being separated off.

Particularly preferred condensates are those based on:

A) phenolsulphonic acid and optionally other sulphonated aromatics, in particular aryl sulphones,

B) formaldehyde and optionally

C) one or more compounds selected from the group consisting of the unsulphonated aromatics, urea and urea derivatives.

Very particularly preferred condensates are those based on the abovementioned components A) and B).

Furthermore, particularly preferred condensates are based on:

A) phenolsulphonic acid and bishydroxyphenyl sulphone,

B) formaldehyde and optionally

C) urea.

The molar ratio of phenolsulphonic acid and bishydroxyphenyl sulphone (diphenol sulphone) is preferably 80:20 to 10:90, in particular 50:50 to 20:80.

The mixture of phenolsulphonic acid and bishydroxyphenyl sulphone is preferably reacted with 0.2 to 2.0 mol equivalents of formaldehyde per aromatic monomer, in particular 0.3 to 1.0 mol equivalent.

The amount of condensate used for the retanning is preferably 1 to 20% by weight, in particular 2 to 10% by weight, based on the iron-tanned leather.

The invention also relates to a process for the production of leather, in particular of leather having a softness greater than 15 units according to IUP/36, preferably greater than 20 units, characterized in that an iron-tanned leather is retanned with a condensate based on:

A) sulphonated aromatics,

B) aldehydes and/or ketones and optionally

C) one or more compounds selected from the group consisting of the unsulphonated aromatics, urea and urea derivatives,

with the proviso that the content of naphthalenesulphonic acid/formaldehyde condensate and condensates based on phenol and formaldehyde is less than 25% by weight, preferably less than 5% by weight, based on the total amount of condensate.

The above mentioned preferred embodiments of the condensates are also applicable to the process according to the invention.

The iron tanning is effected in general so that the pickled pelt is treated with an iron salt, such as mentioned above.

The tanning is preferably effected in water at a temperature of 0-60° C., preferably 20-37° C.

After addition of the iron salts for the tanning, the tanning liquor should have a pH of 1.0 to 3.2, preferably of 1.4 to 2.5. After an appropriate time of 30 min to 24 h, preferably 1 h to 6 h, for penetration, the pH of the tanning liquor is increased for fixing the iron salts. A basic compound, e.g. sodium hydroxide, carbonate, bicarbonate or formate, calcium carbonate or magnesium oxide, is used for this purpose. A pH range of 3.0 to 6.0, preferably 3.1 to 4.0, should preferably be reached.

The iron-tanned leather thus obtained has a shrinkage temperature of greater than 70° C., preferably greater than 75° C. The iron-tanned leather has a uniform yellow colour. It can, for example, be mechanically after-treated, for example by partly drying, shaving, etc. on conventional tannery machines.

The process is preferably carried out by a procedure in which the pelt for iron tanning is pretreated under acidic conditions, in particular with an organic polycarboxylic acid. The preferably used pickled pelts for the iron tanning are preferably pretreated under acidic conditions, in particular at a pH of 2-5, particularly preferably 3-4. A delimed and bated pelt is preferably used in this acidic pretreatment.

Compounds such as carboxylic acids, such as formic acid, acetic acid or oxalic acid, or inorganic acids, such as sulphuric acid, or acidic salts of sulphuric acid or mixtures thereof are particularly used for the pickling.

It has been found that the addition of di- or polyfunctional carboxylic acids, for example polymeric or nonpolymeric compounds, have a particularly positive influence on the properties of the leather in the acidic pretreatment.

Particularly preferred nonpolymeric acids are difunctional carboxylic acids, such as succinic acid, maleic acid, glutaric acid and/or adipic acid; trifunctional carboxylic acids, such as citric acid, or polymeric carboxylic acids, such as (co)polymerized products with the use of (meth)acrylic acid, maleic acid or itaconic acid or derivatives thereof.

These acids are preferably used in an amount of 0.5 to 10% by weight, based on the pelt used, in particular 1-4% by weight.

The acidic pretreatment preferably takes place by a procedure in which pickle is added to the pelt used in an amount such that the pH of the bated pelt is reduced to a value of 2-5, in particular to 3-4. The pickling compounds are preferably added to the pelt in aqueous solution in a tanning drum. This is effected in general at a temperature of 0 to 60° C., in particular at 20 to 37° C. Pretreatment is preferably effected for 10 min to 24 h, in particular 30 min to 2 h.

A fatliquoring agent is particularly preferably also added to the acidic pretreatment. Fatliquoring agents preferred for this use are stable as an emulsion or solution in water to low pH and high electrolyte concentrations. They consist, for example, of sulphonated, sulphated or sulphited fats, based on long-chain alkanes, alcohols, carboxylic acids or esters of natural or synthetic origin, e.g., fish oils, neatsfoot oils, vegetable oils or synthetic oils. A further description of such fatliquoring agents is to be found in R. P. Daniels, Fatliquoring and Softening Agents, World Leather, 2001, 68-70.

For the retanning process, the water content of the iron-tanned leather is preferably reduced by samming, and the thickness of the leather is then corrected if necessary by shaving.

The retanning process preferably takes place in aqueous liquor in a tanning barrel at a temperature of 0 to 70° C., in particular of 20 to 50° C., and optionally comprises further auxiliaries, such as, for example, polymers, fatliquoring agents, colorants, acids and bases, in addition to the condensates according to the invention.

Fatliquoring agents preferred for this use are, for example, sulphonated, sulphated or sulphited fats, based on long-chain alkanes, alcohols, carboxylic acids or esters of natural or synthetic origin, for example fish oils, neatsfoot oils, vegetable oils or synthetic oils.

The dyes useful herein are generally water-soluble dyes, customarily used in leather applications, for example, those from the groups consisting of the acid dyes, direct dyes, metal complex dyes or substantive dyes.

The polymers preferred for the application are high molecular weight water-soluble or water-dispersible products, for example from the (co)polymerization reaction of unsaturated acids and derivatives thereof, having, for example, a filling or fatliquoring effect on leather.

Acids and bases are useful in changing the pH of the aqueous liquor in order to influence the penetration properties of the compounds used or to fix them.

The condensates used according to the invention are preferably used in 20 to 1000, preferably 50 to 200, % aqueous liquor, based on the weight of the leather used, in a pH range of 3.0 to 8.0, preferably 3.5 to 6.5. The addition of 1-20%, preferably 2-10%, of the products can be effected in one or more steps. Further auxiliaries used can likewise be added in one or more steps, together with or separately from the products according to the invention.

The retanning process is carried out in 1-48 h, preferably in 1.5-24 h, in particular in 2-8 h.

The sequence of a retanning process is to be illustrated by examples 7-9, but is in no way restricted to these.

The invention furthermore relates to leather having an iron content of 1 to 7% by weight, characterized in that it contains at least one condensate based on:

A) sulphonated aromatics,

B) aldehydes and/or ketones and optionally

C) one or more compounds selected from the group consisting of the unsulphonated aromatics, urea and urea derivatives,

with the proviso that the content of naphthalenesulphonic acid/formaldehyde condensate and those condensates based on phenol and formaldehyde is less than 25% by weight, preferably less than 5% by weight, based on the total amount of condensate.

The leather according to the invention preferably has a softness greater than 15 units, measured according to IUP/36, preferably greater than 20, in particular greater than 30, units.

The invention is further by the following illustrative but non-limiting examples.

### EXAMPLES

1. Condensate A

Phenolsulphonic acid and bishydroxyphenyl sulphone are condensed in a molar ratio of 1:3 in aqueous solution at pH 6-9 with 2 mol of formaldehyde at 100-120° C., adjusted to pH 3.5 with sulphuric acid and to an acid number (AN) of 120 with phthalic acid and dried.

2. Condensate B

Phenolsulphonic acid (65% solution) sodium salt is mixed with bishydroxyphenyl sulphone (55% suspension) in the molar ratio 2.5:1. 2.5 equivalents of formaldehyde (30% solution) are added to the hot mixture and condensation is effected for 3 h at 112-115° C. The crude condensate is adjusted to an acid number of 100 with adipic acid and dried.

3. Condensate C (comparative example analogous to Tanigan® BN)

Naphthalene is sulphonated with 1.4 equivalents of H₂SO₄ at 145° C. for 2 h. A mixture of 1000 g of the naphthalenesulphonic acids thus obtained, 800 g of bishydroxyphenyl sulphone and 250 ml of 37% formaldehyde solution is condensed at 100-120° C. for 3 h. The product obtained is adjusted to pH 3.5 and an AN of 80 with sodium hydroxide solution and phthalic acid and is spray-dried. (DE-A-10 002 048, example 1).

4. Condensate D (comparative example)

Naphthalene is sulphonated with 1.4 mol of H₂SO₄ for 3 h at 145° C., condensed with 0.66 mol of formaldehyde for 3 h, cooled, adjusted to pH 3.5 and an AN of 50 with sodium hydroxide solution and glutaric acid and is spray-dried. (DE-A-10 002 048, example 3).

5. Condensate E (comparative example analogous to Basyntan® DLX)

The condensate from the strongly acidic reaction of 1 mol of phenol with 0.5 mol of sulphuric acid, 1 mol of urea and 0.9 mol of formaldehyde at 100-110° C. is buffered with 0.2 mol of sodium hydroxide solution. The intermediate thus obtained is condensed with additional 0.8 mol of phenol and 1.2 mol of formaldehyde, cooled, adjusted to pH 3.5 and an AN of 80 with sodium hydroxide solution, formic acid and phthalic acid and spray-dried.

10 6. Tanning process A, tanning with iron salts using a fatliquoring agent. Starting material: split cattle pelt, 3.0 mm. All stated amounts are based on pelt weight.

| | | | | Time | |
|---|---|---|---|---|---|
| | % | Product | ° C. | min | Remark |
| Washing | | Water | 35 | | |
| Deliming | 100 | Water | 35 | | |
| | 2.0 | Ammonium sulphate | | | |
| | 0.3 | Sodium bisulphite | | 10 | |
| | 0.2 | Emulsifier (ethoxylated fatty | | | |
| | | acid) | | | |
| Bating | 1.1 | Bating enzyme (protease) | | 90 | pH: 9.1 |
| | | | | | Liquor |
| | | | | | discharged |
| Washing | | Water | 20 | | |
| Pretreatment | 20 | Water | 20 | | |
| Pickling | 6.0 | Sodium chloride | | 5 | ° Bé: >6 |
| | 0.3 | Preservative (active ingredient | | | |
| | | CMK) | | | |
| | 4.0 | Fatliquoring agent (based on | | | |
| | | sulphated synthetic oils) | | | |
| | 3.0 | Methacrylic acid copolymer | | | |
| | 1.0 | Adipic acid | | 480 | pH: 4.6 |
| | 1.0 | Formic acid 85% 1:10 | | 15 | |
| | 0.5 | Sulphuric acid | | 60 | pH: 3.4 |
| Tanning | 13.5 | Basic iron(III) sulphate 45% | | 120 | pH: 1.7; penetration |
| Basification | 100 | Water | | | |
| | 2.0 | Sodium formate | | 30 | pH: 2.3 |
| | 0.7 | Magnesium oxide | | 30 | pH: 3.0 |
| | 0.7 | Magnesium oxide | | 30 | pH: 4.2 |
| Washing | | Water | | | |

7. Tanning process B, tanning with iron salts without the use of a fatliquoring agent

starting material: split cattle pelt, 2.5 mm. All stated amounts are based on pelt weight.

| | | | | Time | |
|---|---|---|---|---|---|
| | % | Product | ° C. | min | Remark |
| Washing | | Water | 35 | | |
| Deliming | 100 | Water | 35 | | |
| | 2.0 | Ammonium sulphate | | | |
| | 0.3 | Sodium bisulphite | | 10 | |
| | 0.2 | Emulsifier (ethoxylated fatty | | | |
| | | acid) | | | |
| Bating | 1.1 | Bating enzyme (protease) | | 90 | pH: 9.1 |
| | | | | | Liquor |
| | | | | | discharged |
| Washing | | Water | 20 | | |
| Pretreatment | 20 | Water | 20 | | |
| Pickling | 6.0 | Sodium chloride | | 5 | ° Bé: >6 |
| | 0.3 | Preservative (active ingredient | | | |
| | | CMK) | | | |
| | 2.5 | Glutaric acid | | 60 | pH: 4.4 |
| | 1.0 | Formic acid 85% 1:10 | | 15 | |
| | 0.5 | Sulphuric acid | | 60 | pH: 3.4 |
| Tanning | 6 | Iron(III) sulphate | | 120 | pH: 1.7; penetration |
| Basification | 100 | Water | | | |
| | 1.1 | Sodium carbonate 1:10 | | 30 | pH: 2.0 |
| | 1.1 | Sodium carbonate 1:10 | | 30 | pH: 2.7 |
| | 1.1 | Sodium carbonate 1:10 | | 30 | pH: 3.3 |
| Washing | | Water | | | |

8. Tanning process C, retanning, comparison of different retanning agents in a model formulation. Starting material: shaved, iron-tanned leather, thickness 1.4 mm. All stated amounts are based on shaved weight.

| | Amount | | Product | Time | Remark |
|---|---|---|---|---|---|
| Washing | 200.0 | % | Water 20° C. | 10 min | discharge |
| Neutralization | 100.0 | % | Water 40° C. | | |
| | 1.0 | % | Sodium formate | | |
| | 2.0 | % | Sodium bicarbonate | 1 h | |
| | 0.7 | % | Sodium bicarbonate | overnight | |
| | | | Liquor discharged | | |
| Retanning | 100.0 | % | Water | | discharge |
| | 5.0 | % | Retanning agent A-E | | 100% strength |
| | | | | 2 h | |
| | | | Liquor discharged, drying | | |

Comparison of the leathers from tanning process C, thickness 1.3-1.5 mm:

| | According to the invention | | Comparative examples | | |
|---|---|---|---|---|---|
| Sample | A | B | C | D | E |
| Softness, | very soft | soft | hard | hard | hard |
| subjective | | | | | |
| Softness | 21 | 16 | 9 | 10 | 8 |
| IUP/36 | | | | | |
| Body | full | full | less full | empty | empty |
| Colour | light beige | beige, reddish | beige | brown | beige, |
| | | | | | yellowish |

Objective softness test according to IUP/36 of the BLC Leather Technology Center with measuring instrument ST 300 from Heights Design Production Ltd., Halifax, UK

Evaluation: The leathers produced according to the invention are not only substantially softer than the comparative examples but also have advantages with regard to body (very full) and colour (very light).

9. Tanning process D: Retanning based on shaved leather from tanning process B (cattle, thickness 1.1 mm) using the product according to the invention from example 1 for the production of an automotive leather. All stated amounts are based on shaved weight.

| | % | Product | ° C. | Time min | Remark |
|---|---|---|---|---|---|
| Washing | 200 | Water | 40 | 15 | |
| | | | | | Liquor |
| | | | | | discharged |
| Neutralization | 100 | Water | 20 | | |
| | 1.0 | Sodium bicarbonate | | | |
| | 2.0 | Retanning agent (example 1) | | 30 | |
| | 4.0 | Synthetic fatliquoring agent | | 60 | pH 5.2 |
| | | | | | Liquor |
| | | | | | discharged |
| Retanning | 100 | Water | 20 | | |
| Fatliquoring | 5.0 | Synthetic fatliquoring agent | | | |
| Dyeing | 4.0 | Resin tanning agent | | 30 | |
| | 1.0 | Chestnut | | | |
| | 5.0 | Retanning agent (example 1) | | | |
| | 2.0 | Black dye | | 60 | |
| | 100 | Water | 50 | 5 | |
| | 2.0 | Synthetic fatliquoring agent 1:4 | | | |
| | 2.0 | Sulphated fish oil 1:4 | | 30 | |
| | 1.0 | Retanning agent (example 1) | | 60 | pH 5.2 |
| Fixing | 1.0 | Formic acid 1:10 | | 15 | |
| | 1.5 | Formic acid 1:10 | | 30 | pH 3.7 |
| | | | | | Liquor |
| | | | | | discharged |
| Washing | | Water | 20 | 5 | |
| | | | | | Liquor |
| | | | | | discharged |

The leather thus obtained and dyed deep black throughout is dried on a toggle frame, conditioned, staked and milled.

Softness according to IUP/36: 40 units

10. Tanning process D: Retanning based on shaved leather from tanning process A (cattle, thickness 1.6 mm) using the products according to the invention from examples 1 and 2 for the production of very soft upholstery nappa leather. All stated amounts are based on shaved weight.

| | % | Product | ° C. | Time min | Remark |
|---|---|---|---|---|---|
| Washing | 200 | Water | 40 | 15 | |
| | | | | | Liquor |
| | | | | | discharged |
| Neutralization | 100 | Water | 40 | | |
| | 2.0 | Sodium bicarbonate | | | |
| | 2.0 | Retanning agent (example 2) | | 30 | |
| | 3.0 | Sulphated fish oil | | 60 | pH 6.2 |
| | | | | | Liquor |
| | | | | | discharged |
| Retanning | 100 | Water | 30 | | |
| Fatliquoring | 3.0 | Sulphated fish oil | | | |
| Dyeing | 3.0 | Synthetic fatliquoring agent | | | |
| | 4.0 | Resin tanning agent | | 60 | |
| | 5.0 | Retanning agent (example 1) | | | |
| | 2.0 | Blue dye | | 60 | |
| | 100 | Water | 50 | 5 | |
| | 2.0 | Synthetic fatliquoring agent 1:4 | | | |
| | 2.0 | Sulphated fish oil 1:4 | | 30 | |
| | 2.0 | Retanning agent (example 2) | | 60 | pH 5.5 |
| Fixing | 1.2 | Formic acid 1:10 | | 15 | |
| | 1.5 | Formic acid 1:10 | | 30 | pH 3.6 |
| | | | | | Liquor |
| | | | | | discharged |
| Washing | | Water | 20 | 5 | |
| | | | | | Liquor |
| | | | | | discharged |

The brilliant blue leather thus obtained is dried by suspending, conditioned, staked and milled.

Softness according to IUP/36: 55 units.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the retanning of iron-tanned leather, comprising applying to iron-tanned leather, condensates based on:
A) sulphonated aromatics,
B) aldehydes and/or ketones and optionally
C) one or more compounds selected from the group consisting of the unsulphonated aromatics, urea and urea derivatives
with the proviso that naphthalenesulphonic acid/formaldehyde condensate content and phenol and formaldehyde condensate content is in each case less than 25% by weight, based on the total amount of condensate.

2. The process according to claim 1, wherein a leather having a softness of greater than 15 units, measured according to IUP/36, is obtained.

3. The process to claim 1, characterized in that the condensate is based on:
A) phenolsulphonic acids and optionally other sulphonated aromatics,
B) formaldehyde and optionally
C) one or more compounds selected from the group consisting of the unsulphonated aromatics, urea and urea derivatives.

4. The process according to claim 1, wherein the condensate is based on:
A) phenolsulphonic acid and bishydroxyphenyl sulphone and
B) formaldehyde and optionally
C) urea.

5. The process according to claim 1, wherein the condensate is used in an amount of 1 to 20% by weight, based on the iron-tanned leather.

6. The process according to claim 4, wherein the ratio of phenolsulphonic acid to bishydroxyphenyl sulphone being 80:20 to 10:90.

7. Process for the production of iron-tanned leather according to claim 1, wherein the iron-tanned leather is derived from pelt which is pretreated under acidic conditions before the iron tanning.

8. Leather having an iron content of 1-7% by weight, that contains at least one condensate based on:
A) sulphonated aromatics,
B) aldehydes and/or ketones and optionally
C) one or more compounds selected from the group consisting of the unsulphonated aromatics, urea and urea derivatives,
with the proviso that naphthalenesulphonic acid/formaldehyde condensate content and phenol and formaldehyde condensate content is less than 25% by weight, based on the total amount of condensate.

9. Leather according to claim 8, having a softness of greater than 15 units, measured according to IUP/36.
